(19) United States
(12) Patent Application Publication
(10) Pub. No.: US 2008/0281442 A1
(43) Pub. Date: Nov. 13, 2008

(54) Control Device For Displacing At Least One Machine Axis Of A Machine Tool Or Production Machine

(75) Inventors: Bruno Huckemann, Herzogenaurach (DE); Gunter Schwesig, Erlangen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Münich (DE)

(21) Appl. No.: 10/599,568

(22) PCT Filed: Mar. 16, 2005
(86) PCT No.: PCT/EP2005/051220

§ 371 Date: Oct. 2, 2006

(30) Foreign Application Priority Data
Apr. 1, 2004 (DE) 10 2004 016 121.6

(51) Int. Cl. G05B 15/00; G06F 19/00; G05G 1/00

(52) U.S. Cl. 700/85; 74/491; 700/180

(57) ABSTRACT

A control device for displacing at least one machine axis of a machine tool or production machine includes a control element that can deviate from a position of rest. Set values for controlling or regulating the machine can be generated according to the extent and duration of the deviation. During a progessive deviation of the control element and when the deviation of the control element is in a stationary state, a pulse-shaped mechanical feedback can be conveyed via the control element to the operator for at least one generated change in the set value. This results in the creation of a control device that provides the operator with a mechanical feedback over the path of displacement.

The invention relates to a control device for displacing at least one machine axis of a machine tool or production machine.

Within the framework of the present invention, the term machine tools is understood to mean single or multi-axis turning, milling, drilling or grinding machines, for example. Within the framework of the present invention, machine tools also include machining centers, linear and rotating transfer machines, laser machines and hobbing or gear-cutting machines. Common to all of these is that a material is machined wherein this machining can be carried out on multiple axes. Within the framework of the present invention, production machines include textile, paper, plastic, wood, glass, ceramic and stone processing machines as well as robots, for example. Machines in the field of reshaping technology, packaging technology, printing technology, conveying technology, elevator technology, transport technology, hoists, cranes and production and manufacturing lines are likewise included under production machines within the framework of the present invention.

With older machines, e.g. in the case of a hand-operated lathe, a machine axis, which is provided in the form of a support that can be moved along an axis, and on which a cutting tool is fixed, is still displaced by means of hand cranks. In doing so, a so-called rose, which is connected to the crank, indicates the distance moved by the machine axis by means of one hundred graduations, for example. The operator has to count the number of revolutions at the same time.

In modern machine tools, the hand crank is replaced by position-controlled motors, and the rose by an incremental handwheel. Incremental handwheels are used for manually displacing the machine axes in so-called manual traverse mode. In this case, the interpolator in the numerical controller of the machine is generally switched off, and set values, in particular position set values, are generated directly by the handwheel for the open or closed loop control system. The handwheel therefore corresponds to an incremental angular encoder system. As a general rule, one hundred square-wave signal periods in the form of two tracking signals phase-displaced by 90° electrical are generated for 360° of mechanical rotation, usually by means of an optical or magnetic sensor. The tracking signals are converted into position set values in the machine controller by means of counters. The selected machine axis then follows the specified position set values from the handwheel. The scale of the handwheel generally has one hundred graduations, i.e. in this case one hundred different set values are generated for each mechanical revolution, which differ from one another by one increment according to the graduations. In addition, with commercially available handwheels, there is a mechanical or magnetic click, which produces a mechanical feedback for each graduation, i.e. for each position set value, during the turning process. The click therefore occurs for each graduation mark. A precise and cost-intensive electrical and mechanical system is required for an exact correspondence of the generated tracking signals, graduation indication and click, although actually only a set value has to be generated.

From hand-operated machines to modern machines, a certain control pattern has developed.

Here, in the manual process, i.e. when turning the handwheel, the operator looks directly at the machine axis to be displaced without at the same time having to look at the scale divisions of the handwheel or at the displacement distance often indicated on a monitor screen in modern machines. From the clicking of the handwheel corresponding to the graduations of the handwheel, the operator knows from the mechanical feedback in the form of the handwheel click by what displacement distance he has displaced the machine axis even without looking directly at the screen or the handwheel.

Recently, so-called joysticks or joy-wheels have been used for displacing machine axes, which produce a distance/angle-deflection-dependent signal, preferably by means of a non-contact sensor, for manually displacing machine axes. In contrast to the handwheel, when the joystick or joy-wheel is deflected, the speed of the displacement movement is generally executed in proportion to the deflection of the joystick or joy-wheel. The further the joystick or joy-wheel is deflected, the faster the machine axis is displaced. When the operator releases the joystick or joy-wheel, the control element returns to its rest position, i.e. to its zero setting, due to resetting elements, which may be in the form of springs, and the displacement process is stopped.

Commercially available joysticks or joy-wheels do not have a click, as is the case with a handwheel for example. Such a click along the deflection of the joystick or joy-wheel actuating element would also not make sense, as this is not proportional to the distance traveled by the machine axis because, as already mentioned above, the machine axis will also be displaced further even when the deflection of the control element is static, i.e. for example, in the case of a deflection where the operator maintains a certain magnitude of deflection over a longer period of time.

The use of joysticks or joy-wheels for displacing machine axes in machine tool or production machines has therefore previously been associated with the disadvantage that the displaced distance must always be checked by the operator with reference to a numerical display on a monitor screen, as a result of which, in many cases, the operator is prevented from monitoring the displaced distance by direct visual perception of the machine axis, as the operator is often unable to keep the indicated displacement distance and the machine axis in view at the same time. In practice, this often leads to undesirable collisions, e.g. between a tool and a workpiece, as the operator concentrates only on the traverse display on the monitor screen, and does not recognize the risk of an unwanted collision arising on the machine in time.

Control elements with force feedback in the form of handwheels or three-axis joysticks are known from the dissertation “Mobiles Maschinen—und Prozessinteraktionssystem” (Mobile machine and process interaction system), page 9 to 11 (Reports from production technology, Shaker Verlag, Volume April 2001 by Rainer Daude), wherein a representation of the operating forces occurring are fed back to the operator through the control element by means of a force feedback device. Such feedback devices, which model the operating forces occurring for the benefit of the operator, are also specifically referred to in the trade as so-called tactile feedback devices, although, there is no perception by touch of the feedback signal in the strict sense of the word. In the case of tactile feedback, the forces occurring during the machining process are passed on to the control element in reduced modified form in order to give the operator a mechanical appreciation of the forces occurring during the machining process.

The task of the present invention is to create a control device, which gives the operator a mechanical feedback over the displacement distance.

The problem is solved by a control device for displacing at least one machine axis of a machine tool or production machine, wherein the control device has a control element, which can be deflected from a rest position, wherein set values for an open loop controller or a closed loop controller of the machine can be generated depending on the magnitude and duration of the deflection, wherein during a deflection process of the control element and in the steady state of the deflection of the control element a pulse-shaped mechanical feedback can be fed back to an operator for at least one change in the set value generated by means of the control element.

A first advantageous embodiment of the invention is characterized in that the set values are provided in the form of position set values or speed set values. Position set values or speed set values are the set value variables that are normally used within an open loop or closed loop control system for displacing a machine axis.

Moreover, it is advantageous that the control device is designed in the form of a joystick, a joy-wheel or a computer mouse. Joysticks, joy-wheels and computer mice are control devices that are commonly used in engineering.

Furthermore, it is advantageous if the speed of the change of the set values increases disproportionately with the magnitude of the deflection when a certain deflection is exceeded. This enables the machine axis to be displaced quickly.

Furthermore, it is advantageous that the pulse-like mechanical feedback can be generated electromagnetically. A pulse-like mechanical feedback can be generated particularly easily by electromagnetic means.

A further advantageous embodiment of the invention is characterized in that the control device can be represented on a monitor screen in the form of a corresponding virtual handwheel. By this means, the operator is provided with an additional visual indication, which he can interpret particularly easily, as the form of a handwheel is generally well known to him from many years of practical experience.

A further advantageous embodiment of the invention is characterized in that, in the steady state of the deflection of the control element, a pulse-shaped mechanical feedback can be fed back to an operator via the control element for each generated change in the set value. This enables the operator to achieve a particularly high resolution of the displacement process of the machine axis.

Three exemplary embodiments of the invention are shown in the drawing and are described in more detail below. In the drawing

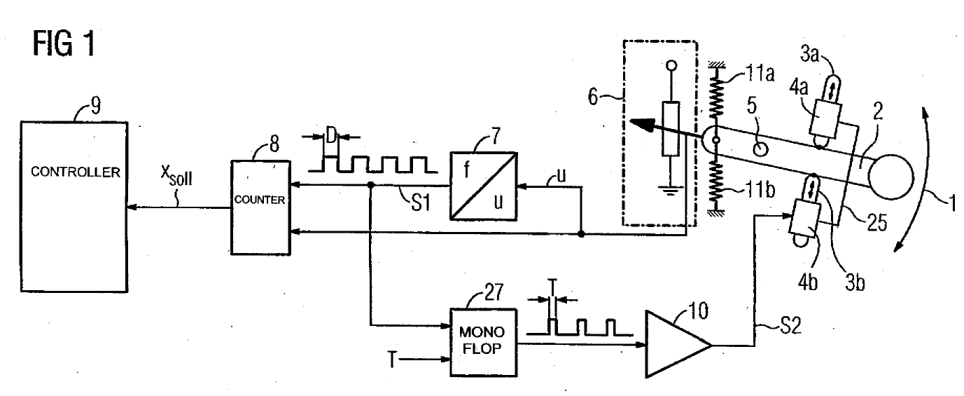

FIG. 1 shows a representation of the control device according to the invention, wherein this is designed as a joystick,

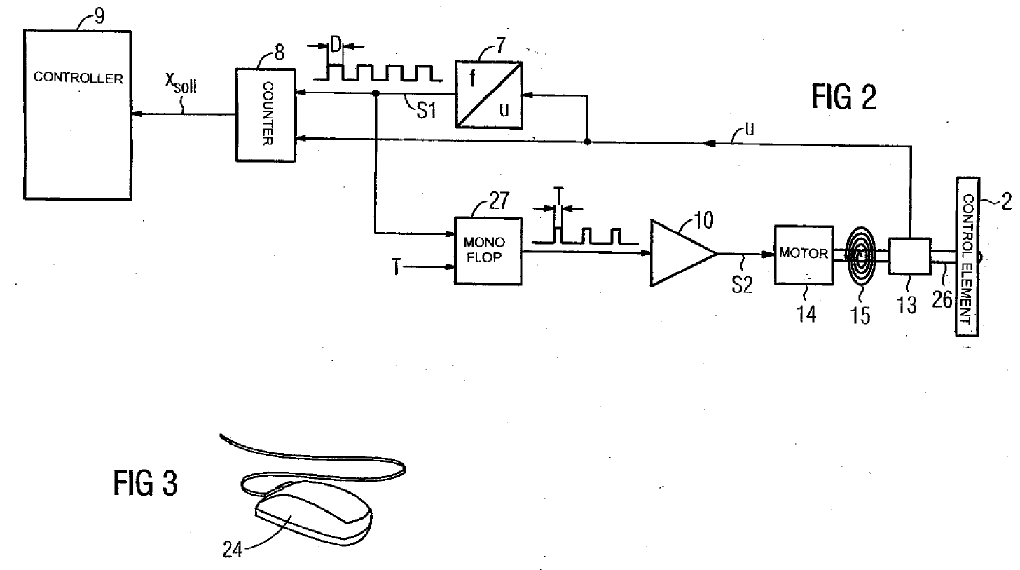

FIG. 2 shows a further representation of the control device according to the invention, wherein this is designed as a joy-wheel,

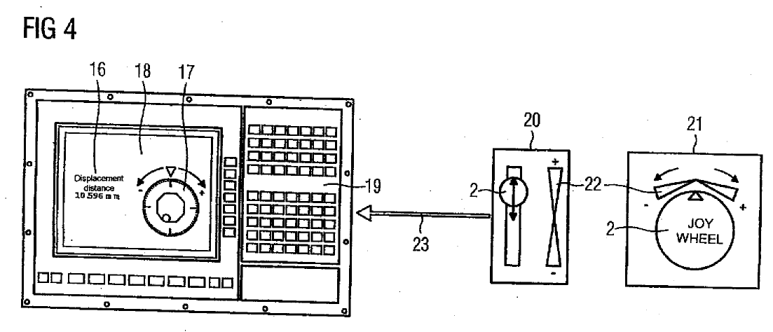

FIG. 3 shows a further representation of the control device according to the invention, wherein this is designed as a schematically shown computer mouse, and

FIG. 4 shows a representation of a virtual handwheel.

The control device according to the invention is shown in FIG. 1 in the form of an exemplary embodiment, wherein in FIG. 1 the control device is designed as a one-dimensional joystick. Naturally, it is also conceivable that the control device according to the invention be designed in the form of a multi-dimensional joystick. A deflection 1 of a control element 2, which in the exemplary embodiment is designed in the form of a lever, is measured by a sensor 6. In the exemplary embodiment, the sensor 6 is designed in the form of a potentiometer, which is shown only schematically. Naturally, other embodiments of the sensor 6 are also conceivable in this case. The control element 2 is mounted by means of a bearing 5 so that it can swivel up and down. Two reset elements, which are provided in the exemplary embodiment in the form of two spring elements 11a and 11b, ensure that the control element 2 automatically returns to a rest position, i.e. to its zero position, after a manual deflection 1.

A voltage signal u from the sensor 6 proportional to the magnitude of the deflection 1 is fed as an input variable to a voltage/frequency converter 7. This produces a pulsed signal S1 depending on the voltage level of the voltage signal u. Here, the frequency of the signal S1 increases with increasing deflection 1. The signal S1 is fed together with the voltage signal u as an input variable to a counter 8. With every rising edge of the signal S1 a counter status of the counter 8 is either incremented or decremented depending on the level of the voltage signal u. In the exemplary embodiment, the counter status is incremented when the deflection is downwards, and the counter status is decremented when the deflection is upwards. Depending on the instantaneous counter state, set values Xₛₑₜ are generated by the counter 8 and fed to a controller 9. Here, the controller 9 can also be designed as a closed loop controller. The controller 9 now displaces the machine axis, e.g. a milling head, along an axis of the machine. In the exemplary embodiment, the set values are generated in the form of position set values. As an alternative, it is of course also possible to feed the set values to the controller 9 in the form of speed set values.

Here, each rising edge of the square-wave signal S1 corresponds to one graduation, i.e. one increment, e.g. of a conventional handwheel described in the introduction to the description.

Now, in order to produce a mechanical feedback for the operator similar to the click of a conventional handwheel, the signal S1 is fed to a monoflop 27. This produces a rectangular shaped pulse with constant duration T for each rising edge of the signal S1. At the same time, the pulse duration T must be chosen to be no greater than the duration D of the square-wave amplitude of the signal S1 at maximum possible deflection 1 of the control element 2. The monoflop 9 therefore acts as a pulse shortener. The output signal of the monoflop 9 is fed to an amplifier 10, which amplifies the signal, and in such a way produces the signal S2 at its output. The signal S2 is fed to an electromagnetically operating arrangement consisting of two coils 4a and 4b and, located within the coils, two starting magnets 3a and 3b, which are connected to the control element 2. The two coils are connected by means of an electrical connection 25 and are wound in the opposite direction. A magnetic field is produced in the coils by the signal S2, as a result of which the bar magnet 3a and the bar magnet 3b each move in opposite directions and in such a way act on the control element 2. As a result of the pulsed form of the signal S2, a pulse-shaped mechanical feedback is generated for the operator via the control element 2 for every change to a set value Xₛₑₜ generated.

It is of course also possible, however, not to generate a pulse-shaped mechanical feedback via the control element 2 for every change in the set value, but, for example, depending on the required resolution, a pulse-shaped mechanical feedback can be generated only for every second, every third or any sub-quantity of changes in the set value, so that a pulse-shaped mechanical feedback can be fed back to an operator for at least one generated change in the set value.

A further exemplary embodiment of the control device according to the invention is shown in FIG. 2. Here, the control device according to FIG. 2 is designed in the form of a joy-wheel. The control element in the exemplary embodiment according to FIG. 2 is designed in the form of a wheel 2. The wheel 2 is connected at its center by means of a shaft 26 to an electric motor 14, to a rotary transducer 13, and to a reset element 15, which in the exemplary embodiment is designed as a helical spring. A rotational movement of the wheel 2 is detected by the rotary transducer 13, which according to FIG. 1 produces a voltage signal u proportional to the deflection. In other respects, the embodiment shown in FIG. 2 corresponds to the embodiment in FIG. 1 described above. The same elements in FIG. 2 are therefore given the same references as in FIG. 1. Unlike the exemplary embodiment according to FIG. 1, the signal S2 produced by the amplifier 10 is fed to the electric motor 14, and in such a way generates a pulse-shaped mechanical feedback for the operator. The way in which the embodiment of the remaining elements shown in FIG. 2 works corresponds to the embodiment shown in FIG. 1.

The control device according to the invention can naturally, as FIG. 3 shows, also be provided in the form of a computer mouse 24. The deflectable control element can then be provided in the form of a rotatable ball, for example. It is of course also conceivable that the control device according to the invention can be provided in the form of a so-called 3D computer mouse, with which a voltage-dependent signal u proportional to the deflection can be generated by swiveling and tilting in space. In this case, the deflectable control element is provided by the housing of the 3D computer mouse itself.

Furthermore, it is of course also conceivable that the control device according to the invention be designed so that the speed of the change of the set values no longer increases in proportion to the deflection but disproportionately with the magnitude of the deflection when a certain deflection is exceeded. This also provides the option within a single control device of enabling a so-called rapid displacement of a machine axis.

Furthermore, it is also possible, as shown in FIG. 4, that the control device can be represented in the form of a corresponding virtual handwheel 17 on a monitor screen 18 of a control panel 19 for controlling the machine tool or production machine. In doing so, along with a numerical display 16 of the set value, the set value is also represented by means of a virtual handwheel 17, which turns on the monitor screen 18. By means of a joystick 20 or a joy-wheel 21 or a computer mouse, which for clarity is no longer shown, not only is the machine axis displaced, but also the virtual handwheel 17 is virtually turned corresponding to the displaced distance by deflecting the respectively associated control element 2. The connection between control panel 19 and joystick 20 or joy-wheel 21 is indicated by an arrow 23. As a result of this, the operator is enabled a traditional view of a handwheel 17 although the machine physically only has a joystick and/or a joy-wheel 21 and/or a computer mouse.

Of course, it is also conceivable that the set values for several axes be generated simultaneously with a single-axis displacement of the control element, and in this way several machine axes can be displaced simultaneously with one deflection movement of the control device according to the invention.

The direction of the deflection of the control element 2 is indicated to the operator with the help of an additional deflection display 22.

1.-7. (canceled)

8. A control device for displacing at least one machine axis of a machine tool or production machine, said control device comprising:
a control element adapted to be deflected from a rest position;
a set value representing a deflection; and
means for providing a pulse-shaped mechanical feedback to an operator for at least one change in the set value.

9. The control device of claim 8, wherein the set value represents a magnitude.

10. The control device of claim 8, wherein the set value represents a duration.

11. The control device of claim 8, wherein the at least one change in a set value is generated in a steady state deflection of the control element using the control element.

12. The control device of claim 8, wherein the at least one change in a set value is generated during a deflection process of the control element using the control element.

13. The control device of claim 8, wherein the set value is a position set value.

14. The control device of claim 8, wherein the set value is a speed set value.

15. The control device of claim 8, constructed as a member selected from the group consisting of joystick, joy-wheel, and computer mouse.

16. The control device of claim 8, wherein a change in speed of the set value increases disproportionately with a magnitude of the deflection when a given deflection is exceeded.

17. The control device of claim 8, further comprising electromagnetic means for providing the pulse-shaped mechanical feedback.

18. The control device of claim 8, further comprising a monitor screen, said control device being represented on the monitor screen in the form of a corresponding virtual handwheel.

19. The control device of claim 8, wherein a pulse-shaped mechanical feedback is provided to an operator for each change in the set value.

20. A control method for displacing at least one machine axis of a machine tool or production machine, said control method comprising the steps of:
detecting a position of a control element which is adapted to be deflected from a rest position;
comparing the position of the control element to a set value representing a deflection; and
providing a pulse-shaped mechanical feedback to an operator for at least one change in the set value.

21. The control method of claim 20, further comprising the step of representing the control element on a monitor screen as a corresponding virtual handwheel.

22. The control method of claim 20, wherein a pulse-shaped mechanical feedback is provided to an operator for each change in the set value.
